(19) United States
(12) Patent Application Publication
(10) Pub. No.: US 2011/0063235 A1
(43) Pub. Date: Mar. 17, 2011

(54) PORTABLE ELECTRONIC DEVICE

(75) Inventors: TZU-CHENG YU, Santa Clara, CA (US); YIN-LI CHANG, Shindian (TW); GUO-LIANG YEH, Shindian (TW)

(73) Assignee: FIH (HONG KONG) LIMITED, Kowloon (HK)

(21) Appl. No.: 12/627,053

(22) Filed: Nov. 30, 2009

(30) Foreign Application Priority Data
Sep. 11, 2009 (CN) 200910306905.0

(51) Int. Cl. G06F 3/041; G09G 5/00

(52) U.S. Cl. 345/173; 345/156

(57) ABSTRACT

An exemplary portable electronic device includes a housing, a sensing unit, a signal converting unit, and a processor. The sensing unit, the signal converting unit, and the processor are electrically connected in series and mounted in the housing. The housing includes an operating section formed at one end of the housing as part of the housing. The sensing unit is mounted in the operating section, and configured for detecting the direction of elastic deformation and relative displacement of the operating section in different directions to generate a corresponding command signal. The signal converting unit is configured for transforming the command signal from the sensing unit. The processor receives the signal from the signal converting unit, and generates a control signal to achieve different operations corresponding to the direction of elastic deformation and the relative displacement of the operating section.

### BACKGROUND

1. Technical Field

The disclosure generally relates to portable electronic devices, more particularly, to a portable electronic device with game function.

2. Description of the Related Art

Nowadays, more and more portable electronic devices, such as mobile phones, personal digital assistants (PDAs), have game functions. The electronic games are increasingly complicated to meet the desires of users, thus, a plurality of input devices, such as keys, scroll wheel, joystick, etc, are set on the portable electronic devices to easily and quickly input commands and operate the games.

However, despite the input devices being small they still increase the size and the weight of the portable electronic devices, which does not meet the development trend of miniaturization. Moreover, since the input devices are small, they are inconvenient to operate.

Therefore, there is room for improvement within the art.

### BRIEF DESCRIPTION OF THE DRAWINGS

Many aspects of a portable electronic device can be better understood with reference to the following drawings. The components in the drawings are not necessarily drawn to scale, the emphasis instead being placed upon clearly illustrating the principles of the exemplary portable electronic device. Moreover, in the drawings, like reference numerals designate corresponding parts throughout the several views. Wherever possible, the same reference numbers are used throughout the drawings to refer to the same or like elements of an embodiment.

FIG. 1 is a block view of a portable electronic device, according to an exemplary embodiment.

FIG. 2 is a front view of the portable electronic device, according to the exemplary embodiment.

FIG. 3 is a first direction schematic view of an operating section of the portable electronic device shown in FIG. 2.

FIG. 4 is a second direction schematic view of the operating section shown in FIG. 2.

FIG. 5A is a third direction schematic view of the operating section shown in FIG. 2.

FIG. 5B is a right side schematic view of the operating section shown in FIG. 5A.

FIG. 6A is a fourth direction schematic view of the operating section shown in FIG. 2.

FIG. 6B is a right side schematic view of the operating section shown in FIG. 6A.

### DETAILED DESCRIPTION

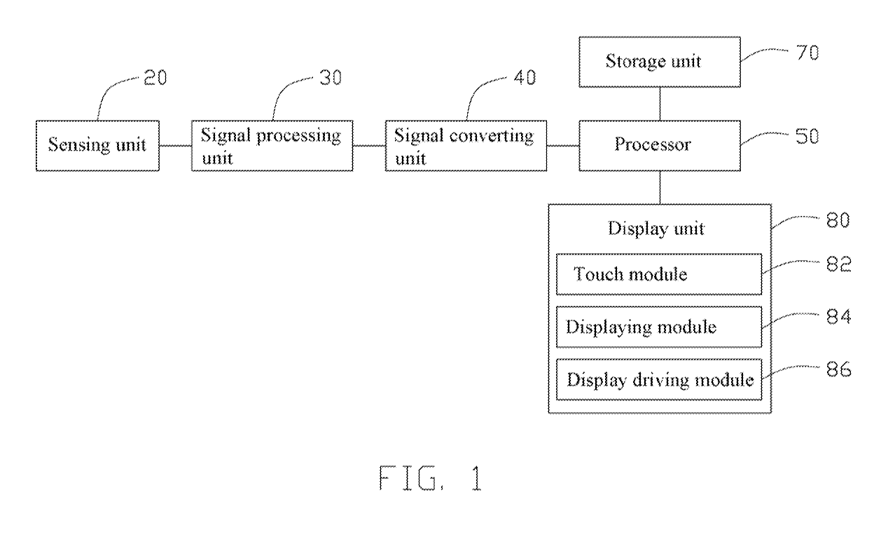

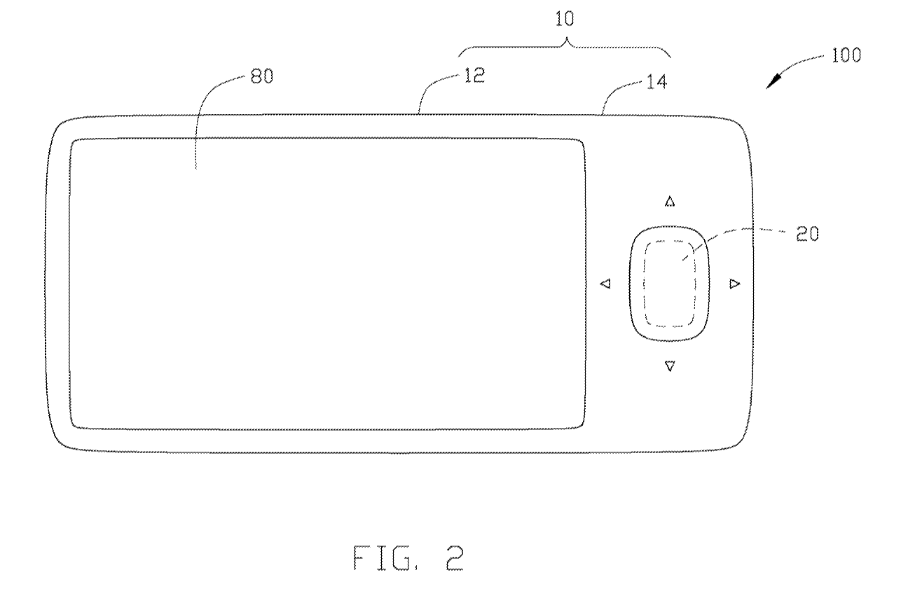

FIGS. 1-2 show an exemplary embodiment of a portable electronic device 100, such as a mobile phone, a PDA, etc with game functions. The mobile phone is taken here as an exemplary application. The portable electronic device 100 includes a housing 10, a sensing unit 20, a signal processing unit 30, a signal converting unit 40, a processor 50, a storage unit 70, and a display unit 80. The sensing unit 20, the signal processing unit 30, the signal converting unit 40, the processor 50, and the display unit 80 are electrically connected in series, and the processor 50 is electrically connected to the storage unit 70.

The housing 10 includes a holding section 12 and an operating section 14 formed at one end of the holding section 12. The holding section 12 and the operating section 14 can form the housing 10. The holding section 12 is configured for accommodating the signal processing unit 30, the signal converting unit 40, the processor 50, the storage unit 70, and the display unit 80.

The operating section 14 can be made from elastic materials, such as rubber, thermoplastic polyurethanes (TPU), etc. The operating section 14, as one part of the housing 10, should be flexible and capable of being twisted to generate elastic deformation under external force. Similarly, the holding section 12 can also be made from the elastic materials as described above according to the design needs, as long as the portable electronic device 100 can be operated normally.

The sensing unit 20 can be an existing acceleration sensing device, mounted in the operating section 14 of the housing 10. The sensing unit 20 includes an acceleration sensor such as a three-axis acceleration sensor, and is configured for detecting the direction of elastic deformation and relative displacement of the operating section 14 in three-dimensional direction according to the elastic deformation of the operating section 14, resulting in generating a corresponding command signal.

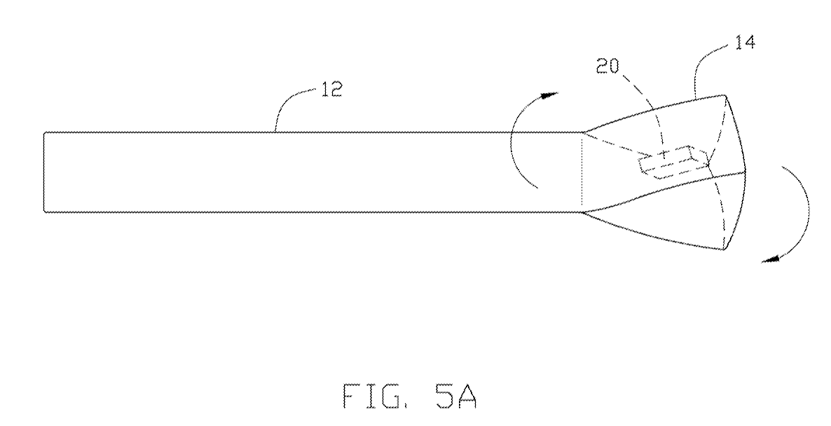

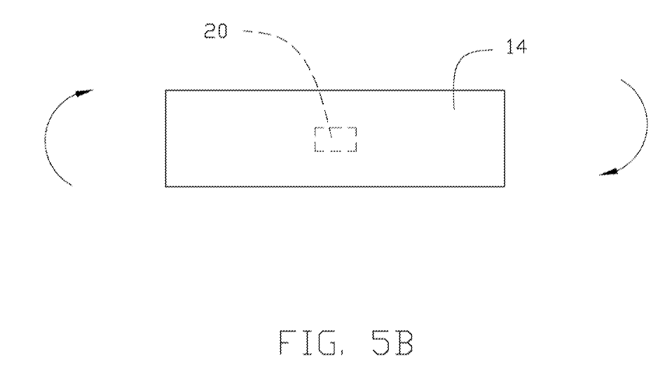

The sensing unit 20 generates a corresponding command signal according to the direction of elastic deformation and the relative displacement of the operating section 14 when operated. For example, in racing games, referring to FIGS. 5A-5B, when a user forward twists the operating section 14, that is the side close to the user of the operating section 14 as viewed by the user is above the plane of the holding section 12 and the other side away from the user of the operating section 14 is below the plane of the holding section 12, the sensing unit 20 generates a corresponding command signal previously associated with this action, according to detecting the direction of the elastic deformation of the operating section 14. The sensing unit 20 can also determine a velocity of the twisting according to the relative displacement of the operating section 14 due to the twisting action performed on the operating section 14.

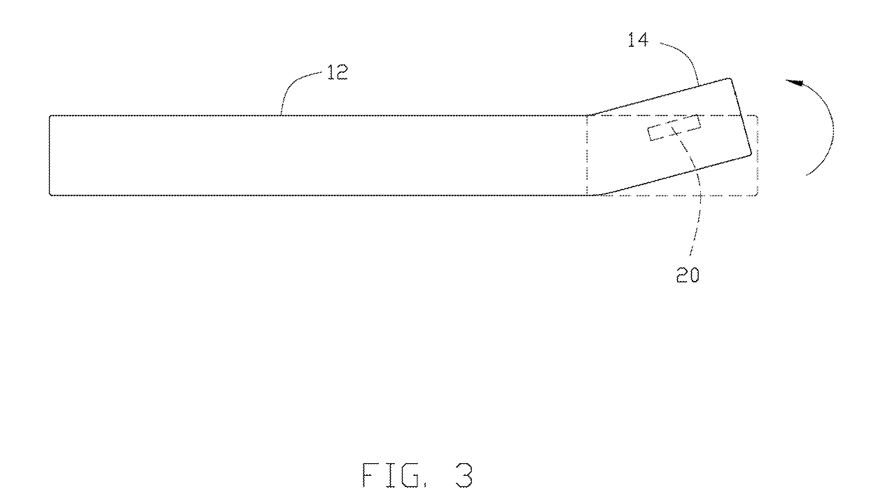

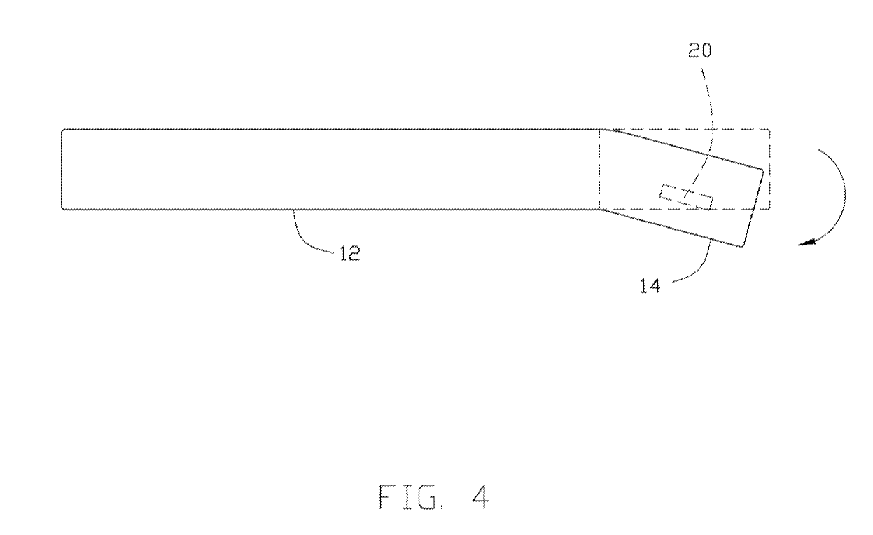

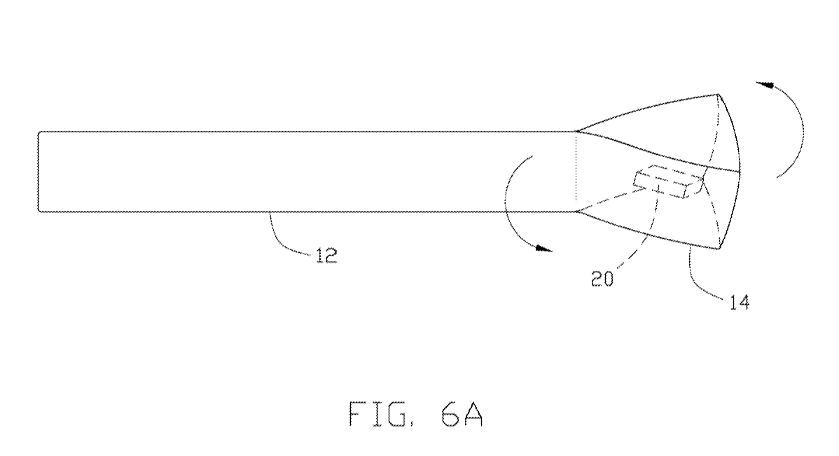

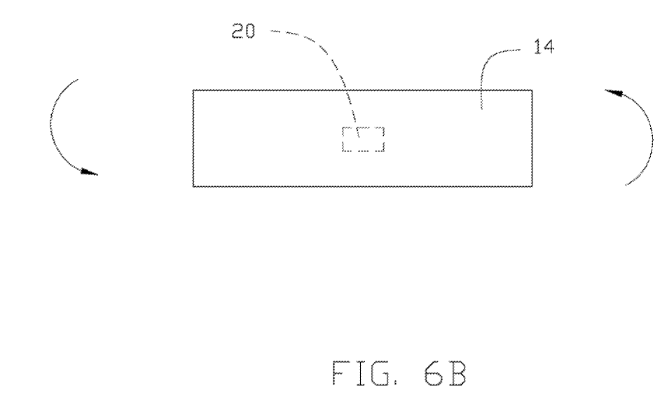

Similarly, referring to FIGS. 6A-6B, when the user back twists the operating section 14, that is the side close to the user of the operating section 14 as viewed by the user is below the plane of the holding section 12 and the other side away from the user of the operating section 14 is above the plane of the holding section 12, the sensing unit 20 generates a corresponding command signal previously associated with this action, according to detecting the direction of the elastic deformation of the operating section 14. The sensing unit 20 can also determine a velocity of the twisting according to the relative displacement of the operating section 14 due to the twisting action performed on the operating section 14. Referring to FIGS. 3-4, when the user bends the operating section 14 below or above the plane of holding section 12, the sensing unit 20 generates a corresponding command signal associated with this action, according to detecting the direction of the elastic deformation of the operating section 14. The sensing unit 20 determines a bending velocity according to the relative displacement of the operating section 14 due to the bending action performed on the operating section 14.

The signal processing unit 30 is configured for processing, such as amplifying, buffering, improving signal noise ratio (SNR), the command signal from the sensing unit 20 and transmitting the processed command signal to the signal converting unit 40. The signal converting unit 40 can be an existing analog to digital converter (ADC), which is configured for transforming the command signal from an analog signal into a digital signal.

The processor 50 can be integrated with the central processing unit (CPU) of the portable electronic device 100. The processor 50 is configured for receiving the digital signal from the signal converting unit 40 and generating a control signal after processing the digital signal. The storage unit 70 can be an existing flash, an electrically erasable programmable read-only memory (EEPROM), etc. The storage unit 70 is configured for storing varieties of control procedures of the portable electronic device 100.

The display unit 80 includes a touch module 82, a displaying module 84, and a display driving module 86, which are electrically connected with each other. The touch module 82 can be an existing resistive touch panel, a capacitive touch panel, an electromagnetic touch panel, etc. The touch module 82, as an input interface of the user, is configured for inputting operation information by touching. The displaying module 84 can be an existing liquid crystal display module (LCM), a cathode ray tube (CRT), etc. The displaying module 84, as an output interface of the user, is configured for displaying various information and operation instructions. The display driving module 86 can use an existing display driver, which is configured for driving the displaying module 84 to display various information and operation instructions.

Referring to FIGS. 3-6B, when the portable electronic device 100 with game function is in use to operate a game, a user operates and twists/bends the operating section 14 of the housing 10 in any direction, the operating section 14 generates elastic deformation and produces relative displacement. The sensing unit 20 generates a corresponding command signal associated with the detected elastic deformation and relative displacement of the operating section 14. The signal processing unit 30 receives and processes the command signal. The signal converting unit 40 receives the command signal form the signal processing unit 30 and transforms the command signal into digital signal. The processor 50 receives, calculates, and processes the digital signal, and reads the control procedures of the storage unit 70 to play the game, so that the display unit 80 displays various information and operation instructions under the control of the processor 50. Thus, the user can easily operate the portable electronic device 100 and play the game.

In the portable electronic device 100 with game function of the exemplary embodiment, the housing 10 defines a flexible operating section 14, which can produce elastic deformation in different directions. The sensing unit 20 detects the elastic deformation and relative displacement of the operating section 14, so that the portable electronic device 100 can achieve various operations corresponding to the elastic deformation and relative displacement. Thereby, the operating section 14, as one part of the housing 10, can be used as the input devices, such as keys, joysticks and so on, thus contributing to reducing the size and the weight of the portable electronic device 100, which is convenient to operate the games.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A portable electronic device, comprising:
a housing including an operating section, the operating section, as part of the housing, formed at one end of the housing;
a sensing unit mounted in the operating section, and configured for detecting the direction of elastic deformation and relative displacement of the operating section in different directions to generate a corresponding command signal;
a signal converting unit mounted in the housing and electrically connected to the sensing unit, the signal converting unit configured for transforming the command signal from the sensing unit; and
a processor mounted in the housing and electrically connected to the signal converting unit, wherein the processor receives the signal from the signal converting unit, and generates a control signal to achieve different operations corresponding to the direction of elastic deformation and the relative displacement of the operating section.

2. The portable electronic device as claimed in claim 1, wherein the sensing unit includes an acceleration sensor and detects the direction of elastic deformation and relative displacement of the operating section in three-dimensional to generate the corresponding command signal.

3. The portable electronic device as claimed in claim 1, further comprising a signal processing unit electrically connected to the sensing unit and the signal converting unit, the signal processing unit configured for amplifying, buffering, and improving signal noise ration of the command signal from the sensing unit.

4. The portable electronic device as claimed in claim 1, further comprising a storage unit electrically connected to the processor, the storage unit configured for storing varieties of control procedures corresponding various operation information.

5. The portable electronic device as claimed in claim 1, further comprising a display unit electrically connected to the processor, the display unit configured for inputting and displaying various operation information.

6. The portable electronic device as claimed in claim 5, wherein the display unit includes a touch module as an input interface of a user, and the touch module is configured for inputting operation information by touching.

7. The portable electronic device as claimed in claim 5, wherein the display unit further includes a displaying module as an output interface of a user, and the displaying module is configured for displaying various information and operation instructions.

8. The portable electronic device as claimed in claim 7, wherein the display unit further includes a display driving module electrically connected to the displaying module, and the display driving module is configured for driving the displaying module to display various information and operation instructions.

9. The portable electronic device as claimed in claim 1, wherein the housing further includes a holding section formed at another end of the housing; and the holding section is configured for holding the signal processing unit and the processor.

10. The portable electronic device as claimed in claim 9, wherein the operating section is adjacent to the holding section, and the holding section and the operating section are integrated to form the housing.

11. The portable electronic device as claimed in claim 9, wherein the holding section is made from rubber or thermoplastic polyurethanes.

12. The portable electronic device as claimed in claim 1, wherein the operating section is made from rubber or thermoplastic polyurethanes.

13. A portable electronic device, comprising:
a housing including an operating section, the operating section, as part of the housing, formed at one end of the housing;
a sensing unit mounted in the operating section, and configured for detecting the direction of elastic deformation and relative displacement of the operating section in different directions to generate a corresponding command signal;
a signal converting unit mounted in the housing and electrically connected to the sensing unit, the signal converting unit configured for transforming the command signal from the sensing unit;
a processor mounted in the housing and electrically connected to the signal converting unit, the processor receiving the signal from the signal converting unit, and generating a control signal to achieve different operations corresponding to the direction of elastic deformation and the relative displacement of the operating section;
a storage unit mounted in the housing and electrically connected to the processor, the storage unit configured for storing varieties of control procedures corresponding various operation information; and
a display unit mounted in the housing and electrically connected to the processor, the display unit configured for inputting and displaying various operation information.

14. The portable electronic device as claimed in claim 13, wherein the sensing unit includes an acceleration sensor and detects the direction of elastic deformation and relative displacement of the operating section in three-dimensional to generate the corresponding command signal.

15. The portable electronic device as claimed in claim 13, further comprising a signal processing unit electrically connected to the sensing unit and the signal converting unit, the signal processing unit configured for amplifying, buffering, and improving signal noise ration of the command signal from the sensing unit.

16. The portable electronic device as claimed in claim 13, wherein the display unit includes a touch module as an input interface of a user, and the touch module is configured for inputting operation information by touching.

17. The portable electronic device as claimed in claim 13, wherein the display unit further includes a displaying module as an output interface of a user and a display driving module electrically connected to the displaying module; the displaying module is configured for displaying various information and operation instructions, and the display driving module is configured for driving the displaying module to display various information and operation instructions.

18. The portable electronic device as claimed in claim 13, wherein the housing further includes a holding section formed at another end of the housing; and the holding section is configured for holding the signal processing unit and the processor.

19. The portable electronic device as claimed in claim 18, wherein the operating section is adjacent to the holding section, and the holding section and the operating section are integrated to form the housing.

20. The portable electronic device as claimed in claim 9, wherein the holding section is made from rubber or thermoplastic polyurethanes and the operating section is made from rubber or thermoplastic polyurethanes.
